(19) United States
(12) Patent Application Publication
(10) Pub. No.: US 2008/0095242 A1
(43) Pub. Date: Apr. 24, 2008

(54) Apparatus and method for determining adaptive encoding mode in H.264 encoder

(75) Inventors: Yong-Hyun Lim, Suwon-si (KR); Young-O Park, Seongnam-si (KR); Yun-Je Oh, Yongin-si (KR); Young-Hun Joo, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/904,701

(22) Filed: Sep. 28, 2007

(30) Foreign Application Priority Data
Oct. 19, 2006 (KR) 2006-101843

(51) Int. Cl. H04N 7/26

(52) U.S. Cl. 375/240.24; 375/E07.088

(57) ABSTRACT

An apparatus for determining an encoding mode in an H.264 encoder is provided with a 16×16 macroblock number calculating unit and a threshold updating unit. The 16×16 macroblock number calculating unit calculates means of the number of 16×16 macroblocks. The threshold updating unit compares the number of 16×16 macroblocks of a frame, which is chosen to be currently encoded, with the mean of the number of 16×16 macroblocks among or within the frames, and updates a currently set threshold according to a result of comparing. Then, calculating unit checks the number of times by which the encoding mode is determined by the 16×16 macroblock in a frame whose encoding is currently completed, and the threshold updating unit compares the number of times with the currently set threshold to increase or decrease the threshold according to a result of the comparison.

### CLAIM OF PRIORITY

This application claims the benefit of the earlier filing date, under 35 U.S.C. § 119(a), to that application entitled “Apparatus And Method For Determining Adaptive Encoding Mode In H.264 Encoder,” filed in the Korean Intellectual Property Office on Oct. 19, 2006 and assigned Serial No. 2006-101843, the contents of which are hereby incorporated by reference.

### BACKGROUND OF THE INVENTION

1. Field of the Invention

The present invention relates to an H.264 encoder, and more particularly to an apparatus and a method for determining an encoding mode to maximize encoding efficiency in an H.264 encoder.

2. Description of the Related Art

It is typical that an H.264 encoding scheme defines base technologies for compression of high definition moving pictures in next generation multimedia devices, and can offer a variety of multimedia services even with the transmission of a small amount of data, as it has a superior efficiency of encoding.

Such a high encoding efficiency of a H.264 encoding scheme is owed to a method for determining a mode, which employs an increased number of modes, and a technique for optimizing a complex bit-distortion. The H.264 encoding scheme provides a diversity of encoding parameters, such as a variety of macroblock modes, a variable block size, a number of reference images, etc., to improve the efficiency of encoding of a video signal. Determining an optimal mode among the macroblock modes including these parameters is most important during the process of encoding.

It is typical that a macroblock mode of 16×16 size is most often used as a macroblock mode in the H.264 encoder. Moving picture frames of a Quarter Video Graphics Array (QVGA) grade include many more macro blocks of 16×16 size than other macro blocks size as this is the largest size among the sizes (e.g., 16×16, 16×8, 8×16, 8×8, 8×4, 4×8, and 4×4) of the macro blocks currently used, to enable the processing the volume to be made smaller.

However, all moving picture frames cannot be encoded using the macroblock mode of 16×16 size. This is why, in a case of the macroblock mode of 16×16 size, as the number of pixels included in a macroblock increases (e.g., original moving picture frames in which there occur many motions,) it is hard to express the motions exactly. Further, the quality of pictures of the original moving picture frames can be seriously degraded. Accordingly, the conventional H.264 encoder codes the moving picture frames by using another macroblock mode having a smaller number of pixels. Herein, the conventional H.264 encoder compares the Sum of the Absolute Difference (SAD) with a preset threshold to determine a macroblock mode in order to detect whether the macroblock mode of 16×16 size can be used, or whether another macroblock mode is to be used.

FIG. 1 is a flowchart illustrating an exemplary process of determining an encoding mode of frames in an encoding mode determining apparatus of a conventional H.264 encoder.

With reference to FIG. 1, the conventional encoding mode determining apparatus of the conventional H.264 encoder proceeds to step 100 to calculate a prediction value of a color difference signal by using a motion vector of a luminance signal of a macroblock of 16×16 size. Then, the conventional encoding mode determining apparatus proceeds to step 102 to set an initial position by using the calculated prediction value. Next, a value of the SAD (hereinafter, referred to as “SAD value”) is calculated by the macroblock of 16×16 size (hereinafter, referred to as “16×16 macroblock”) from the set initial position. Thereafter, the conventional encoding mode determining apparatus proceeds to step 106 to check if the currently calculated SAD value is equal to or less than a preset threshold.

If the calculated SAD value is equal to or less than the preset threshold as a result of checking in step 106, the conventional encoding mode determining apparatus determines that a macroblock on the basis of a current initial position can be encoded in a mode of 16×16 macroblock, and proceeds to step 108 to determine encoding by the 16×16 macroblock. The encoding mode which is determined here can be an inter mode coding mode. Next, the conventional encoding mode determining apparatus completes a process of determining an encoding mode of a current macroblock. Then, the conventional encoding mode determining apparatus sets another initial position according to a prediction value of a motion vector, and performs a process of determining an encoding mode on the basis of another set initial position.

However, if the calculated SAD value is more than the preset threshold as a result of checking in step 106, the conventional encoding mode determining apparatus proceeds to step 110 to select one of the macroblock units according to a preset first order among macroblock units of size 16×16, 16×8, 8×16, 8×8, 8×4, 4×8, and 4×4. As would be recognized other macroblock blocks may also be selected. Thereafter, the conventional encoding mode determining apparatus proceeds to step 112 to calculate a prediction value of a motion vector according to a macroblock unit of the selected size, and sets another initial position according to the prediction value of the motion vector. Then, the conventional encoding mode determining apparatus proceeds to step 114 to calculate a SAD value based on the currently set initial position.

After that, the conventional encoding mode determining apparatus proceeds to step 116 to check if the SAD value calculated in step 114 is equal to or less than the preset threshold. If the SAD value calculated in step 114 is equal to or less than the preset threshold, the conventional encoding mode determining apparatus proceeds to step 118 to determine whether a macroblock based on the current initial position can be encoded in a mode of a macroblock of a currently set size, and determines encoding of a macroblock unit of the currently selected size.

Still, if the SAD value calculated in step 114 is more than the preset threshold as determined in step 116, the conventional encoding mode determining apparatus proceeds to step 120 to select a macroblock unit of a size according to the preset next order, and repeatedly performs the procedure of steps 112 to 114 in which calculating an SAD value according to a macroblock unit of a currently selected size in a currently set initial position, and comparing the calculated SAD value with a threshold, are performed.

Consequently, the conventional encoding mode determining apparatus merely sets a prescribed threshold, and determines encoding of the macroblock unit according to the set prescribed threshold. Hence, for instance, encoding can be performed by the macroblock of 16×16 size for almost all moving picture frames. However, when the calculated SAD value is slightly more than the preset threshold, encoding cannot be performed by the macroblock of 16×16 size, and the encoding mode determining apparatus of a conventional H.264 encoder is compelled to perform a process of determining an encoding mode related to a macroblock of a different size for a few macro blocks.

Hence, in this case, because the conventional encoding mode determining apparatus spends time on determining an encoding mode for a few macro blocks, encoding of frames cannot be performed in real time.

### SUMMARY OF THE INVENTION

Accordingly, the present invention has been made to solve the above problems occurring in the prior art and provides additional advantages, by providing an apparatus for determining an adaptive encoding mode in an H.264 encoder.

Another aspect of the present invention to provide a method for determining an adaptive encoding mode in an H.264 encoder.

In one embodiment, there is provided an apparatus for determining an adaptive encoding mode in an H.264 encoder according to an embodiment of the present invention, including a macroblock unit selecting unit for selecting any of a number of macroblock units according to a preset order, and for providing set information related to the set macroblock, a motion vector predicting unit for predicting a motion vector according to a preset motion vector predicting method, and for setting an initial position according to a prediction value of the predicted motion vector; a Sum of the Absolute Difference (SAD) calculating unit for receiving information on the currently set macroblock and information on the initial position, and determining a value of a SAD according to the currently set macroblock unit on the basis of the currently set initial position, a SAD comparing unit for comparing the calculated value of the SAD with a currently set threshold, and for checking if the currently calculated value of the SAD is equal to or less than the currently set threshold, an encoding mode determining unit for determining an encoding mode according to the currently set macroblock unit to select if the currently calculated value of the SAD is equal to or less than the currently set threshold; and a threshold setting unit for determining whether to vary the threshold in a case when the currently set encoding mode corresponds to an encoding mode according to a macroblock unit of a preset size as a result of determining the encoding mode, and for varying the threshold.

In another embodiment, there is provided a method for determining an adaptive encoding mode in a H.264 encoder according to an embodiment of the present invention, including the steps of counting a number determined by the preset macroblock among results of determining an encoding mode of a frame which is currently being encoded loading the mean number of the preset macro blocks by each of frames which has been previously stored, comparing the counted number with the mean number; updating a threshold which is compared with a value of the Sum of the Absolute Difference (SAD) calculated to determine an encoding mode of a macroblock on the basis of a currently set initial position according to a result of comparing; and updating the preset mean number of macro blocks by each of frames, including the preset mean number of macro blocks counted from the frame whose encoding is currently completed.

### BRIEF DESCRIPTION OF THE DRAWINGS

The above features, and advantages of the present invention will be more apparent from the following detailed description taken in conjunction with the accompanying drawings, in which:

FIG. 1 is a flowchart illustrating a process for determining an encoding mode of frames in an encoding mode determining apparatus of a conventional H.264 encoder;

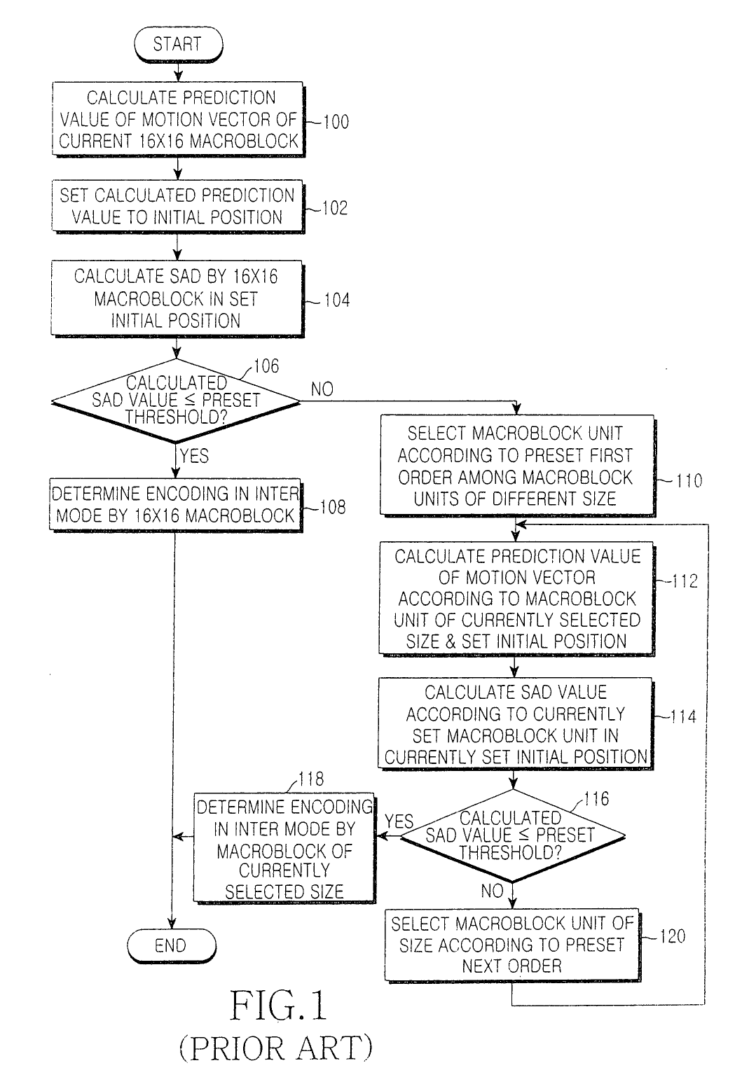

FIG. 2 is a block diagram illustrating an apparatus for determining an encoding mode according to an embodiment of the present invention;

FIG. 3 is a block diagram more specifically illustrating the structure of a threshold setting unit in an apparatus for determining an encoding mode according to the embodiment of the present invention shown in FIG. 2;

FIG. 4 is a flowchart illustrating an operation process of updating a threshold compared with a SAD value in an apparatus for determining an encoding mode according to the embodiment of the present invention shown in FIG. 2;

FIG. 5 is a flowchart illustrating an operation process of setting a weight for a threshold according to the difference of the number of macro blocks in an apparatus for determining an encoding mode according to the embodiment of the present invention shown in FIG. 2; and

FIG. 6 is a flowchart illustrating an operation process of setting a weight for a threshold, according to a history of the number of 16×16 macro blocks, by each of currently stored frames in an apparatus for determining an encoding mode according to the embodiment of the present invention shown in FIG. 2.

### DETAILED DESCRIPTION OF THE INVENTION

Hereinafter, embodiments of the present invention will be described with reference to the accompanying drawings. The same elements will be designated by the same reference numerals all through the following description and drawings although they are shown in different drawings. For the purposes of clarity and simplicity, a detailed description of known functions and configurations incorporated herein will be omitted as it may make the subject matter of the present invention rather unclear.

Basic principles of the present invention are first described. In the present invention, an apparatus for determining an encoding mode is equipped with a 16×16 macroblock number calculating unit and a threshold updating unit. The 16×16 macroblock number calculating unit calculates the number of 16×16 macro blocks and the mean of the number of 16×16 macro blocks. Herein, an encoding mode of 16×16 macro blocks is determined by the number of 16×16 macro blocks in each of frame. The threshold updating unit compares the number of 16×16 macro blocks of a frame which is chosen to be currently encoded with the mean of the number of 16×16 macro blocks, and can update a currently set threshold according to a result of comparing. Then, the 16×16 macroblock number calculating unit checks the number of times by which the encoding mode is determined by the 16×16 macroblock in a frame whose encoding is currently completed, and the threshold updating unit compares the number of times with the currently set threshold to increase or decrease the threshold according to a result of the comparison. Herein, the increased or decreased value of the threshold can be given a weight according to the difference between the number of times by which the encoding mode is determined by the 16×16 macroblock in the frame whose encoding is currently completed, and the mean of the number of times by which the encoding mode is determined by the 16×16 macroblock by existing frames, or according to a history of an encoding mode by the 16×16 macroblock and by currently stored frames. Herein, the history means the order of storage of or the order of the stored frames.

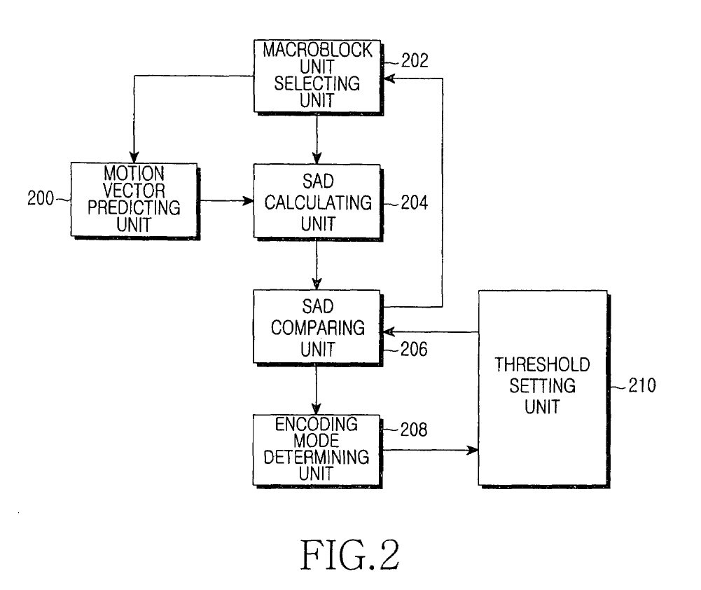

FIG. 2 is a block diagram illustrating an apparatus for determining an encoding mode according to a preferred embodiment of the present invention.

Referring to FIG. 2, the encoding mode determining apparatus according to an embodiment of the present invention includes a motion vector predicting unit 200, a macroblock unit selecting unit 202, a SAD calculating unit 204, a SAD comparing unit 206, an encoding mode determining unit 208, and a threshold setting unit 210.

Herein, the motion vector predicting unit 200 predicts a motion vector according to a method for estimating a motion vector of a H.264 encoder, and sets an initial position according to a prediction value of the predicted motion vector. Next, information on the set initial position is input to the SAD calculating unit 204. Then, the macroblock unit selecting unit 202 sets a 16×16 macroblock unit as an initial set, and provides set information relevant to the set 16×16 macroblock to the SAD calculating unit 204.

Then, in response to a currently set initial position, the SAD calculating unit 204 calculates a SAD value by the 16×16 macroblock, which is then provided to the SAD comparing unit 206.

Next, the SAD comparing unit 206 compares the SAD value with the currently set threshold to check if the currently calculated SAD value is equal to or less than the currently set threshold. If the currently calculated SAD value is equal to or less than the preset threshold, the SAD comparing unit 206 sends, to the encoding mode determining unit 208, a signal that a macroblock based on the current initial position can use an encoding mode of a 16×16 macroblock unit, and the encoding mode determining unit 208 determines the encoding mode of the macroblock based on the current initial position to be a 16×16 macroblock mode. In addition, if an encoding mode of the macroblock based on the current initial position is determined to be the 16×16 macroblock mode, the encoding mode determining unit 208 sends, to the threshold setting unit 210, a signal which is necessary to increase the number of 16×16 macro blocks of a moving picture frame that are currently being encoded.

Thereafter, the threshold setting unit 210 determines whether to increase or decrease the threshold according to the number of 16×16 macro blocks of the moving picture frame which are currently being encoded. Further, in a case of an increase or a decrease of the currently set threshold, i.e., if variation is determined, the threshold setting unit 210 varies the threshold, and provides the varied threshold to the SAD comparing unit 206. Accordingly, the SAD comparing unit 206 replaces the currently preset threshold with the varied threshold received from the threshold setting unit 210.

Meanwhile, if a SAD value calculated by the SAD calculating unit 204 is more than the currently set threshold as a result of comparison by the SAD comparing unit 206, the SAD comparing unit 206 provides, to the macroblock unit selecting unit 202, a signal giving notice that the SAD value is more than the currently set threshold. Then, the macroblock unit selecting unit 202 selects a macroblock unit of a different size, and provides information on the currently selected macroblock unit to the SAD calculating unit 204 and the motion vector predicting unit 200. On this, the motion vector predicting unit 200 sets both a prediction value of the motion vector according to a currently set macroblock unit, and an initial position based on the prediction value of the motion vector, and provides the initial position to the SAD calculating unit 204. In response, the SAD calculating unit 204 calculates a SAD value according to a macroblock unit currently selected by the macroblock unit selecting unit 202 on the basis of a currently newly set initial position.

After that, the SAD value is input to the SAD comparing unit 206. The SAD comparing unit 206 compares the calculated SAD value with the currently set threshold again, and according to a result of comparison, sends a signal for requesting a new macroblock unit set to the macroblock unit selecting unit 202 again, or transmits, to the encoding mode determining unit 208, a signal for giving notice that encoding can be performed according to the currently selected macroblock unit.

If the signal for giving notice that encoding can be performed according to the currently selected macroblock unit is transmitted to the encoding mode determining unit 208, the encoding mode determining unit 208 determines an encoding mode of a macroblock based on the current initial position to be an encoding mode of the currently selected macroblock unit. However, at this time, since the size of the macroblock unit is not 16×16, the encoding mode determining unit 208 does not transmit a signal for increasing the number of 16×16 macro blocks of a moving picture frame currently being encoded to the threshold setting unit 210. Accordingly, in this case, it is not checked whether to vary a threshold according to the number of 16×16 macro blocks.

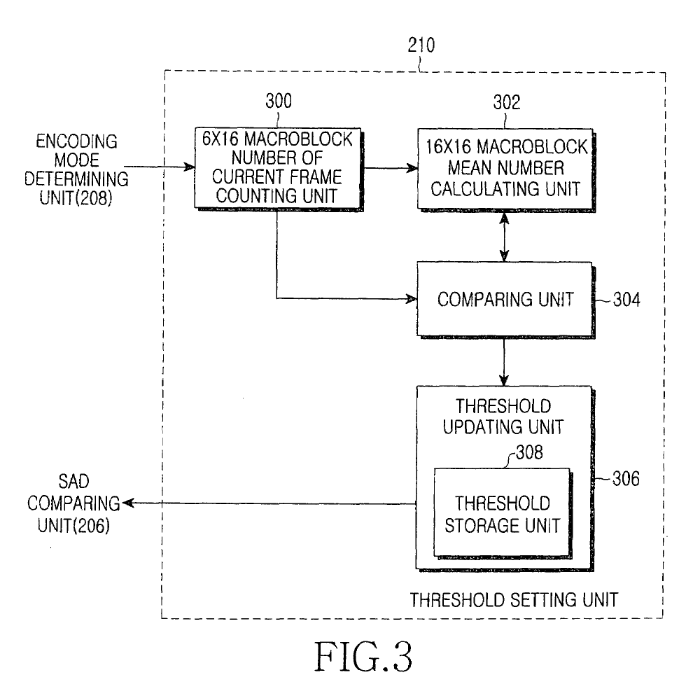

FIG. 3 is a block diagram more specifically illustrating the structure of a threshold setting unit in an apparatus for determining an encoding mode according to the presented embodiment of the present invention.

With reference to FIG. 3, the threshold setting unit 210 includes a 16×16 macroblock number counting unit 300, mean number calculating unit 302, comparing unit 304, and a threshold updating unit 306.

Herein, the 16×16 macroblock number counting unit 300 counts the number of 16×16 macro blocks of a frame which is currently being encoded according to a signal for increasing the number of 16×16 macro blocks from the encoding mode determining unit 208, and provides the number of 16×16 macro blocks included in a frame to the comparing unit 304.

The comparing unit 304 compares the counted number of 16×16 macro blocks (i.e., the number of 16×16 macro blocks included in a current frame) with the mean of the number of 16×16 macro blocks of each of the frames before the frame currently being encoded, which is provided from the mean number calculating unit 302. Next, the comparing unit 304 outputs a result of the comparison to the threshold updating unit 306.

Herein, the mean number calculating unit 302 stores the number of 16×16 macro blocks of each of the previous frames whose encoding has been completed, and calculates the mean of the number of 16×16 macro blocks within each of the frames. Next, the mean number calculating unit 302 provides the mean of the number of 16×16 macro blocks to comparing unit 304. Then, if the comparison of the comparing unit 304 is completed, the mean number calculating unit 302 receives, from the comparing unit 304, the number of macro blocks of the frame whose encoding is currently completed, and calculates the mean of the number of 16×16 macro blocks including the number of macro blocks of the frame whose encoding is currently completed, to update the previous mean with the currently calculated mean of the number of 16×16 macro blocks among the frames or within the frame (referred to herein as “among the frames”).

Meanwhile, if the threshold updating unit 306 receives a result of the comparison from the comparing unit 304, the threshold updating unit 306 determines whether to vary the threshold according to the result of the comparison. Namely, for example, if the counted number of 16×16 macro blocks is equal to or more than the calculated mean of the number of 16×16 macro blocks among the frames, the threshold updating unit 306 determines the increase of the threshold by a preset increment, and increases a threshold currently stored in the threshold storage unit 308. Herein, the preset increment can be an optimized value acquired through an experiment. Then, the threshold updating unit 306 provides the increased threshold to the SAD comparing unit 206. Hereupon, as described in detail, the SAD comparing unit 206 replaces the currently set threshold with the increased threshold, and accordingly, a SAD value calculated from a frame currently being encoded, is compared with the increased threshold. Therefore, in this case, an encoding mode can be determined as a 16×16 macroblock mode.

However, if the counted number of 16×16 macro blocks is less than the calculated mean of the number of 16×16 macro blocks by the frames, the threshold updating unit 306 determines a decrease of the threshold by a preset decrement, and decreases a threshold currently stored in the threshold storage unit 308. Herein, the preset decrement can be an optimized value acquired through an experiment. Then, the threshold updating unit 306 provides the decreased threshold to the SAD comparing unit 206. Hereupon, as described in detail, the SAD comparing unit 206 replaces the currently set threshold with the decreased threshold, and accordingly a SAD value calculated from a frame, currently being encoded, is compared with the decreased threshold. Therefore, in this case, determining an encoding mode as a 16×16 macroblock mode can be even more difficult than in existing cases.

The threshold updating unit 306 can vary the preset increment or the preset decrement as demanded. If the currently counted number of 16×16 macro blocks is a large value and more than the calculated mean of the number of 16×16 macro blocks among each frame, by the prescribed number, or if the currently counted number of 16×16 macro blocks is a small value which is less than the calculated mean of the number of 16×16 macro blocks by each frame, by the prescribed number, the threshold updating unit 306 considers this difference, and can increase or decrease the increment or decrement, respectively.

The encoding mode determining apparatus according to the presented embodiment of the present invention can not only adjust the increment or decrement of the threshold, but also can give a weight according to the history of the number of 16×16 macro blocks by the frames in applying the increment or the decrement to the threshold. In this case, while giving the weight according to the history in storing the number of 16×16 macro blocks by the currently stored frames, the mean number calculating unit 302 according to the presented embodiment of the present invention stores the number of 16×16 macro blocks.

Namely, for example, the number of 16×16 macro blocks of a frame which has been stored long ago, is multiplied by a value which is less than ‘1,’ and the number of 16×16 macro blocks of another frame which has been stored recently, is multiplied by a value which is more than ‘1.’ By using values calculated in this manner, as a greater deal of weight is placed on the number of 16×16 macro blocks of a frame stored most recently, the mean of the number of 16×16 macro blocks by each frame can be also calculated. Therefore, in this case, the number of 16×16 macro blocks according to the history by the frames, is reflected in a variation of the threshold value.

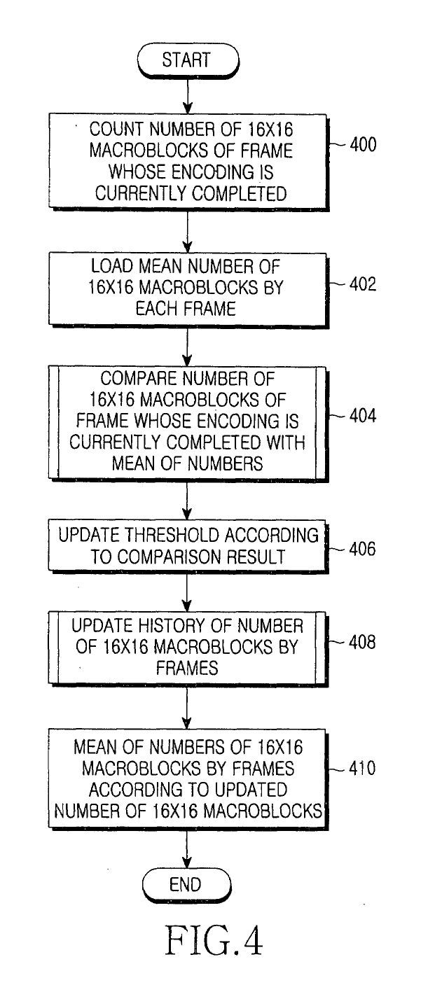

FIG. 4 is a flowchart illustrating an exemplary process of updating a threshold compared with a SAD value in an apparatus for determining an encoding mode according to the presented embodiment of the present invention.

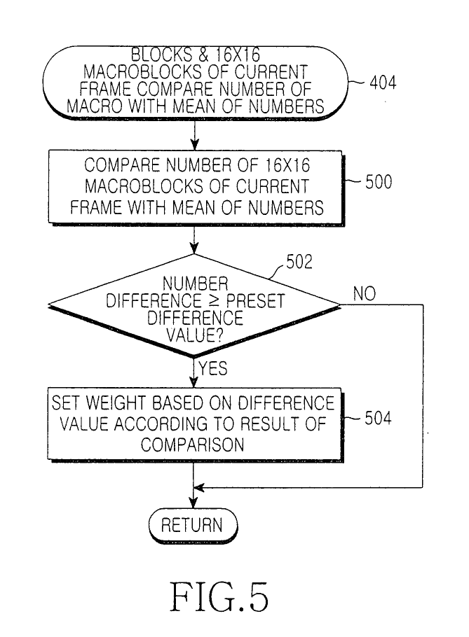

With reference to FIG. 4, the encoding mode determining apparatus according to the preferred embodiment of the present invention proceeds to step 400 to count the number of 16×16 macro blocks of a frame currently being encoded. Then, if encoding of the frame currently being encoded is completed, the encoding mode determining apparatus proceeds to step 402 to load the mean of the number of 16×16 macro blocks among each of the frames stored in the mean number calculating unit 302. Next, the encoding mode determining apparatus proceeds to step 404 to compare the number of 16×16 macro blocks of the frames whose encoding is currently completed with the mean of the number of 16×16 macro blocks among each of the frames. If the difference between the number of 16×16 macro blocks of the frames whose encoding is currently completed, and the mean of the number of 16×16 macro blocks by each of the frames, is more than a prescribed value as a result of the comparison, the encoding mode determining apparatus, as described above, can increase or decrease the increment or the decrement of the threshold by using a weight which reflects this. The increase or a decrease of the threshold is described with reference to FIG. 5.

The encoding mode determining apparatus according to the presented embodiment of the present invention proceeds to step 406 to update the threshold according to a result of the comparison. Herein, if a weight is set according to a case where the difference between the number of 16×16 macro blocks of the frame whose encoding is currently completed, and the mean of the number of 16×16 macro blocks among the frames, is more than a prescribed value, in step 406, the threshold is updated by a value which is reflected in the threshold.

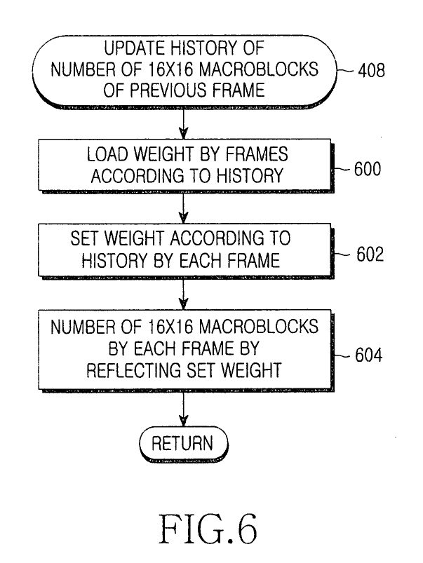

The encoding mode determining apparatus proceeds to step 408 to include, in the history of the number of 16×16 macro blocks by the currently stored frames, information on the number of 16×16 macro blocks of the frames whose encoding is currently completed, which is compared in step 404, and updates the history of the number of 16×16 macro blocks among the frames. Herein, the encoding mode determining apparatus can provide a weight, as described above, according to the history of the number of 16×16 macro blocks by the frames. In this case, the flow of an operation of the encoding mode determining apparatus according to a presented embodiment of the present invention is described with reference to FIG. 6.

Meanwhile, if the history of the number of 16×16 macro blocks by the frames is updated in step 408, the encoding mode determining apparatus proceeds to step 410 to calculate the mean according to the currently updated number of 16×16 macro blocks. Accordingly, the encoding mode determining apparatus increases or decreases the threshold according to the number of 16×16 macro blocks of the frame whose encoding is currently completed, and to the mean of the number of 16×16 macro blocks of the frames whose encoding has been previously completed, and adapts to this state to be able to increase or decrease such a possibility that an encoding mode can be determined as a 16×16 macroblock mode. Hence, the encoding mode determining apparatus can perform encoding in real time according to an H.264 encoding scheme even by a processor having limited processing capability.

FIG. 5 is a flowchart illustrating an exemplary process of setting a weight for a threshold according to the difference of the number of macro blocks in an apparatus for determining an encoding mode according to the presented embodiment of the present invention.

Refer to FIG. 5, if the mean of the number of 16×16 macro blocks by each of the frames is loaded in step 402 illustrated in FIG. 4, the encoding mode determining apparatus according to the preferred embodiment of the present invention proceeds to step 500 to compare the number of 16×16 macro blocks of a current frame with the loaded mean of the number of 16×16 macro blocks by each of the frames. Next, the encoding mode determining apparatus proceeds to step 502 to determine if the difference of the number of 16×16 macro blocks of the current frame is equal to or more than a preset difference value as a result of comparing in step 500. Herein, the preset difference value can be an optimized value acquired through an experiment or a value obtained by a design requirement and randomly.

If the difference of the number of 16×16 macro blocks of the current frame is equal to or more than the preset difference value as a result of step 502, the encoding mode determining apparatus proceeds to step 504 to set a weight, which increases or varies the threshold, on the basis of the difference value according to a result of the comparison. If the weight is set in step 504, the weight is additionally reflected in the threshold by a preset increment or decrement, which is set in step 406 illustrated in FIG. 4.

Still, if the difference of the number of 16×16 macro blocks of the current frame is less than the preset difference value as a result of determining in step 502, the encoding mode determining apparatus proceeds to step 406 illustrated in FIG. 4, without reflecting the weight in the threshold, and varies the threshold according to the preset increment or decrement. Consequently, if the difference between the number of 16×16 macro blocks of a current frame and the loaded mean of the number of 16×16 macro blocks by each of the frames is equal to or more than a preset difference value, the difference can be additionally reflected in the variation of the threshold.

FIG. 6 is a flowchart illustrating an exemplary process of setting a weight for a threshold, according to a history of the number of 16×16 macro blocks, by each of currently stored frames.

If the threshold is updated in step 406 illustrated in FIG. 4, the encoding mode determining apparatus according to the presented embodiment of the present invention proceeds to step 600 to load weights by frames according to a currently set history. Namely, the weights set according to the history can be values of rates or related to a rate in which the number of 16×16 macro blocks of a frame which has been stored is reflected, and to a rate in which the number of 16×16 macro blocks of a frame which has been reflected.

If the weights by the frames according to the history are loaded, the encoding mode determining apparatus according to the presented embodiment of the present invention proceeds to step 602 to set weights according to the history by each of the frames. Next, the encoding mode determining apparatus proceeds to step 604 to calculate the number of 16×16 macro blocks by the frames, which is reflected in the computation of the mean number according to the weights by the frames according to the history which is currently set.

Accordingly, in this case, if the encoding mode determining apparatus proceeds to step 410 illustrated in FIG. 4, the mean of the number of 16×16 macro blocks by each frame is now able to be calculated according to the number of 16×16 macro blocks by the frames in which the weight is reflected according to the history by each frame. Therefore, in this case, in the encoding mode determining apparatus according to the present invention, the weights according to the history of each of the frames, are reflected in the variation of the threshold. However, in this case, the number of 16×16 macro blocks by each frame which is used in the calculation of the mean number, is not stored as the number of 16×16 macro blocks by each actual frames.

The merits and effects of preferred embodiments, as disclosed in the present invention, and as so configured to operate above, will be described as follows.

Hence, in moving picture frames which are currently encoded, a preset threshold can be increased or decreased according to the number of times by which an encoding mode is determined by the macro block, so that the more the number of times by which the encoding mode is determined by the macro block of 16×16 size, is increased, the more an encoding mode of much more macro blocks can be determined as a 16×16 macro block. Moreover, encoding of moving picture frames can be performed in real time even in an H.264 encoder equipped with a processor having limited processing capability.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to a certain preferred embodiment thereof, it will be understood by those skilled in the art that various changes in form and details may be made therein without departing from the spirit and scope of the invention. In preferred embodiments of the present invention, determining an encoding mode by even more 16×16 macro block units on the basis of the number of 16×16 macro blocks is described, but the present invention is not limited to this. Namely, only because it is usual that encoding by the 16×16 macro block is most efficient in the-state-of-the-art, the encoding by the 16×16 macro block is assumed. If there exists even more efficient macro block unit than a 16×16 macro block unit, it goes without saying that the present invention can be applied to a more efficient macro block unit. Therefore, the spirit and scope of the present invention must be defined not by described embodiments thereof but by the appended claims and equivalents of the appended claims.

What is claimed is:

1. An apparatus for determining an adaptive encoding mode in an H.264 encoder, the apparatus comprising:
a macroblock unit selecting unit for setting and selecting a number of macroblock units according to a preset order, and for providing set information related to the set macroblock;
a motion vector predicting unit for predicting a motion vector according to a preset motion vector predicting method, and for setting an initial position according to a prediction value of the predicted motion vector;
a Sum of the Absolute Difference (SAD) calculating unit for receiving information on the currently set macroblock and information on the initial position, and for a value of a SAD according to the currently set macroblock unit on the basis of the currently set initial position;
a SAD comparing unit for comparing the calculated value of the SAD with a currently set threshold, and for checking if the currently calculated value of the SAD is equal to or less than the currently set threshold;
an encoding mode determining unit for determining an encoding mode according to the currently set macroblock unit to select if the currently calculated value of the SAD is equal to or less than the currently set threshold; and
a threshold setting unit for determining whether to vary the threshold in a case when the currently set encoding mode corresponds to an encoding mode according to a macroblock unit of a preset size as a result of determining the encoding mode, and for varying the threshold if it is required to vary the threshold.

2. The apparatus as claimed in claim 1, wherein the threshold setting unit comprises:
a macro block number counting unit for counting the number determined by the macroblock of the preset size among results of determining an encoding mode of macro blocks of the frame in a case when encoding of a frame currently encoded is completed;
a mean number calculating unit for storing the number determined by the macroblock of the preset size relevant to each of frames before a frame whose encoding is currently completed, and for calculating the mean of the number;
a comparing unit for comparing the counted number with the mean; and
a threshold updating unit for varying the threshold according to a result of the comparing.

3. The apparatus as claimed in claim 2, wherein the threshold updating unit increases the threshold by a preset increment if the counted number is equal to or more than the mean as a result of the comparing, and decreases the threshold by a preset decrement if the counted number is less than the mean.

4. The apparatus as claimed in claim 3, wherein the threshold updating unit additionally reflects a weight according to a difference value in the preset increment or in the preset decrement if the difference between the counted number and the mean is equal to or more than a prescribed number as a result of the comparing.

5. The apparatus as claimed in claim 2, wherein the mean number calculating unit reflects a weight according to the history by each frame in storing the number determined by the macro block of the preset size relevant to each of the frames before the frame whose encoding is currently completed, and calculates the mean according to the number of macro blocks of the preset size by each of the frames stored by reflecting the weight.

6. The apparatus as claimed in claim 1, wherein the preset macroblock corresponds to a macroblock of 16×16 size.

7. A method for determining an adaptive encoding mode in an H.264 encoder, the method comprising the steps of:
(1) counting the number determined by the preset macroblock among results of determining an encoding mode of a frame which is currently being encoded;
(2) loading the mean number of the preset macro blocks by each of the frames which has been previously stored, if encoding of the frame which is currently being encoded is completed;
(3) comparing the counted number with the mean number;
(4) updating a threshold which is compared with a value of the Sum of the Absolute Difference (SAD) calculated to determine an encoding mode of a macroblock on the basis of a currently set initial position according to a result of comparing; and
(5) updating the preset mean number of macro blocks by each frame, including the preset mean number of macro blocks counted from the frame whose encoding is currently completed.

8. The method as claimed in claim 7, wherein step (4) comprises the steps of:
increasing the threshold by a preset increment if the counted number is equal to or more than the mean number as a result of the comparing; and
decreasing the threshold by a preset decrement if the counted number is less than the mean number.

9. The method as claimed in claim 7, wherein step (3) comprises the steps of:
comparing the counted number with the mean number;
determining if the difference value is equal to or more than the predetermined number as a result of the comparing; and
setting a weight based on the difference value if the difference value is equal to or more than the predetermined number as a result of the determining.

10. The method as claimed in claim 9, wherein step (4) increases the threshold by the sum of the preset increment and the weight of the difference value if the counted number is equal to or more than the mean number as a result of the comparing, and decreases the threshold by the sum of the preset decrement and the weight of the difference value if the counted number is less than the mean number as a result of the comparing.

11. The method as claimed in claim 7, wherein step (5) comprises the steps of:
including, in the history by each frame, the number by the preset macroblock counted from a frame whose encoding is currently completed;
loading a weight by the frames according to the history by the frames;
setting a weight by the frames according to each history by each of the frames;
calculating the number reflection value by the preset macro block by each frame which is reflected in a calculation of the mean of the number of the preset macro blocks by each frame according to the set weight by the frames; and
calculating the mean of the number of preset macro blocks by each frame by using the calculated number reflection value by the preset macro block by each frame.

12. The method as claimed in claim 7, wherein the preset macro block corresponds to a macro block of 16×16 size.

13. A computer-program product providing instruction, which when loaded into a processor causes the processor to execute the steps of:
(1) counting the number determined by the preset macroblock among results of determining an encoding mode of a frame which is currently being encoded;
(2) loading the mean number of the preset macro blocks by each of the frames which has been previously stored, if encoding of the frame which is currently being encoded is completed;
(3) comparing the counted number with the mean number;
(4) updating a threshold which is compared with a value of the Sum of the Absolute Difference (SAD) calculated to determine an encoding mode of a macroblock on the basis of a currently set initial position according to a result of comparing; and
(5) updating the preset mean number of macro blocks by each frame, including the preset mean number of macro blocks counted from the frame whose encoding is currently completed.

14. The product as claimed in claim 13, wherein step (4) comprises the steps of:
increasing the threshold by a preset increment if the counted number is equal to or more than the mean number as a result of the comparing; and
decreasing the threshold by a preset decrement if the counted number is less than the mean number.

15. The product as claimed in claim 13, wherein step (3) comprises the steps of:
comparing the counted number with the mean number;
determining if the difference value is equal to or more than the predetermined number as a result of the comparing; and
setting a weight based on the difference value if the difference value is equal to or more than the predetermined number as a result of the determining.

16. The product as claimed in claim 15, wherein step (4) increases the threshold by the sum of the preset increment and the weight of the difference value if the counted number is equal to or more than the mean number as a result of the comparing, and decreases the threshold by the sum of the preset decrement and the weight of the difference value if the counted number is less than the mean number as a result of the comparing.

17. The product as claimed in claim 13, wherein step (5) comprises the steps of:
including, in the history by each frame, the number by the preset macroblock counted from a frame whose encoding is currently completed;
loading a weight by the frames according to the history by the frames;
setting a weight by the frames according to each history by each of the frames;
calculating the number reflection value by the preset macro block by each frame which is reflected in a calculation of the mean of the number of the preset macro blocks by each frame according to the set weight by the frames; and
calculating the mean of the number of preset macro blocks by each frame by using the calculated number reflection value by the preset macro block by each frame.

18. The product as claimed in claim 13, wherein the preset macro block corresponds to a macroblock of 16×16 size.
